(19) United States
(12) Patent Application Publication
(10) Pub. No.: US 2004/0157139 A1
(43) Pub. Date: Aug. 12, 2004

(54) Method for fabricating color filter

(76) Inventors: Yaw-Ming Tsai, Taichung (TW); Shih-Chang Chang, Hsinchu (TW)

Correspondence Address: LOWE HAUPTMAN GOPSTEIN GILMAN & BERNER, LLP, Suite 310, 1700 Diagonal Road, Alexandria, VA, 22314, US

(21) Appl. No.: 10/364,560

(22) Filed: Feb. 12, 2003

(51) Int. Cl. G02B 5/20; G02F 1/1335

(52) U.S. Cl. 430/7; 347/106

(57) ABSTRACT

This invention relates to a method for fabricating a color filter by forming photoresist or dielectric spacers on the non-pixel area to avoid to blurry with the printed hydrophobic color materials and can get fine color filter with excellent color reappearance. This invention comprises forming a dielectric layer on a substrate; forming a plurality of scan lines and a plurality of data lines on said substrate to define a plurality of pixel areas and a non-pixel area; forming a photoresist layer or a dielectric layer on said dielectric layer; patterning the photoresist layer or the dielectric layer for forming photoresist or dielectric spacers on the non-pixel area; and printing a color material on said plurality of pixel areas by inkjet printing method.

### BACKGROUND OF THE INVENTION

1. Field of the Invention

The invention is relates to a method for fabricating a color filter, more particularly to a method for fabricating a color filter by forming photoresist or dielectric spacers on the non-pixel area to avoid to blurry with the printed color materials and can get fine color filter with excellent color reappearance.

2. Description of the Prior Art

In a conventional liquid crystal display (LCD) apparatus, two electrode substrates are faced with a cell gap. Each of the electrode substrates has electrodes that generate pixels. A liquid crystal layer is held between the two electrode substrates so that the peripheral portion of the liquid crystal layer is sealed. In this manner, the principal portions of the LCD apparatus are constructed.

In a LCD apparatus that can especially display a color image on the screen, a color filter is used. The color filter is constructed by disposing color cells of three primary colors or a plurality of hues such as R, G, and B (red, green, and blue) or Y, M, and C (yellow, magenta, and cyan) corresponding to individual pixels on at least one of the two electrode substrates.

Many fabricating methods of the color filters such as pigment dispersing method, dye dispersing method, electrodepositing method, and printing method have been proposed. In the pigment dispersing method, a pigment is dispersed to a layer to be colored and thereby a color filter is formed. In the dye dispersing method, a dye is dispersed to a layer to be colored and thereby a color filter is formed. In the electrodepositing method, a color filter is formed by electrodeposition. In the printing method, a coloring material of the color filter that is an ink is printed on a substrate using a printing plate such as an intaglio printing plate or an offset plate. The abovementioned methods have been practically used.

But, in such conventional fabricating methods, since the lithography process and the etching process are used repeatedly, the process of the color filter becomes very complicated. In addition, to deal with pixel sizes that are becoming smaller and smaller, the accuracy of the lithography process and the etching process should be improved. It is difficult to fabricate such color filters with high accuracy and high yield. Moreover, more than three times lithography process and the etching process are used to fabricate the color filter of RGB colors. The complication and cost of the above processes will increase accordingly.

In the printing method, although the etching technology is not directly used, the fabrication of the printing plates is very complicated. Moreover, in the printing method, it is difficult to form precise color filters that correspond to the sizes of fine pixels.

Recently, an inkjet printing method of a fine color filter has been proposed. However, when a color filter is formed by the ink-jet print method, the sprayed coloring material may blur with another coloring material at a boundary region thereof so that it is difficult to reproduce clear colors. Thus, even if color filters with very high throughput are formed by an ink jet unit, the reappearance of colors of the color filters is low. Consequently, the color reappearance and display quality of color images of the LCD apparatus using the color filters fabricated by the said inkjet print method are inferior.

### SUMMARY OF THE INVENTION

In the light of the state of the art described above, it is an object of the present invention to provide a method for fabricating a color filter which is immune to the problems of the conventional method for fabricating a color filter described above.

It is another object of this invention to provide a method for fabricating a color filter that the photoresist spacers is formed on the non-pixel area by the scan lines and the data lines as the photomask and the light rays put below the glass substrate to avoid to blurry with the printed color materials and can get fine color filter with excellent color reappearance.

It is a further object of this invention to provide a method for fabricating a color filter that the photoresist spacers is formed on the non-pixel area by the photomask and the light rays put above the glass substrate to avoid to blurry with the printed color materials and can get fine color filter with excellent color reappearance.

It is also an object of this invention to provide a method for fabricating a color filter that the dielectric spacers is formed on the non-pixel area by the photomask and the light rays put above the glass substrate to avoid to blurry with the printed color materials and can get fine color filter with excellent color reappearance.

In view of the above and other objects which will become apparent as the description proceeds, there is provided according to a general aspect of the present invention a method for fabricating color filter which comprises forming a dielectric layer on a first surface of a substrate; forming a plurality of scan lines and a plurality of data lines on said first surface of said substrate to define a plurality of pixel areas and a non-pixel area; forming a photo-sensitive material layer on said dielectric layer; irradiating said substrate with a light rays from a second surface of said substrate located below said first surface of said substrate; developing said photo-sensitive material layer; and printing a color material on said plurality of pixel areas by inkjet printing method.

Base on the idea described above, wherein said scan lines and said data lines cross vertically.

Base on the aforementioned idea, the method for fabricating color filter further comprises a plurality of thin film transistors (TFTs) formed on said substrate.

Base on the idea described above, wherein said scan lines, said data lines and said TFTs are connected electrically.

Base on the aforementioned idea, wherein said light rays is selected from the group consisting of G-line, I-line and deep ultraviolet rays.

Base on the idea described above, wherein said photo-sensitive material layer is a photoresist layer.

Base on the aforementioned idea, wherein the step of printing a color material on said plurality of pixel areas by inkjet printing method further comprises removing said developed photo-sensitive material layer.

In view of the above and other objects which will become apparent as the description proceeds, there is provided according to a general aspect of the present invention a method for fabricating color filter which comprises forming a dielectric layer on a substrate; forming a plurality of scan lines and a plurality of data lines on said substrate to define a plurality of pixel areas and a non-pixel area; forming a photo-sensitive material layer on said dielectric layer; inserting a photomask above said substrate; irradiating said substrate with a light rays through said photomask; developing said photo-sensitive material layer; and printing a color material on said plurality of pixel areas by inkjet printing method.

Base on the idea described above, wherein said scan lines and said data lines cross vertically.

Base on the aforementioned idea, the method for fabricating color filter further comprises a plurality of thin film transistors (TFTs) formed on said substrate.

Base on the idea described above, wherein said scan lines, said data lines and said TFTs are connected electrically.

Base on the aforementioned idea, wherein the pattern of said photomask over said non-pixel area is opaque.

Base on the idea described above, wherein said light rays is selected from the group consisting of G-line, I-line and deep ultraviolet rays.

Base on the aforementioned idea, wherein said photo-sensitive material layer is a photoresist layer.

Base on the idea described above, wherein the step of printing a color material on said plurality of pixel areas by inkjet printing method further comprises removing said developed photo-sensitive material layer.

In view of the above and other objects which will become apparent as the description proceeds, there is provided according to a general aspect of the present invention a method for fabricating color filter which comprises forming a first dielectric layer on a substrate; forming a plurality of scan lines and a plurality of data lines on said substrate to define a plurality of pixel areas and a non-pixel area; forming a second dielectric layer on said first dielectric layer; forming a photoresist layer on said second dielectric layer; inserting a photomask above said substrate; irradiating said substrate with a light rays through said photomask; developing said photoresist layer; etching said second dielectric layer; and printing a color material on said plurality of pixel areas by inkjet printing method.

Base on the idea described above, wherein said scan lines and said data lines cross vertically.

Base on the aforementioned idea, the method for fabricating color filter further comprises a plurality of thin film transistors (TFTs) formed on said substrate.

Base on the idea described above, wherein said scan lines, said data lines and said TFTs are connected electrically.

Base on the aforementioned idea, wherein the pattern of said photomask over said non-pixel area is opaque.

Base on the idea described above, wherein said light rays is selected from the group consisting of G-line, I-line and deep ultraviolet rays.

Base on the aforementioned idea, wherein said dielectric layer is etched by an anisotropic etching method.

Base on the idea described above, wherein the step of etching said second dielectric layer further comprises removing said developed photoresist layer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a view of the plan view of color liquid crystal display device;

FIG. 2 illustrates a cross-section view of color liquid crystal display device according to the first and second embodiments of the present invention;

FIG. 3A˜3B illustrate the schematic process figures according to the first embodiment of the present invention;

FIG. 4A˜4B illustrate the schematic process figures according to the second embodiment of the present invention;

FIG. 5 illustrates a cross-section view of color liquid crystal display device according to the third embodiment of the present invention; and

FIG. 6A˜6B illustrate the schematic process figure according to the third embodiment of the present invention.

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

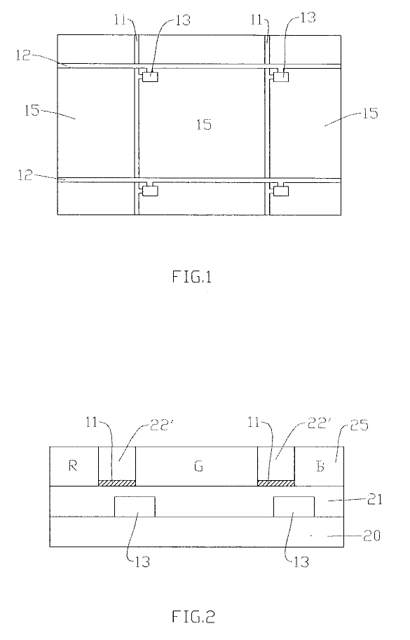

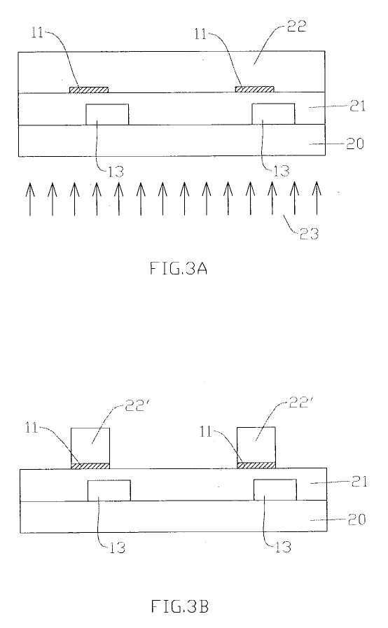

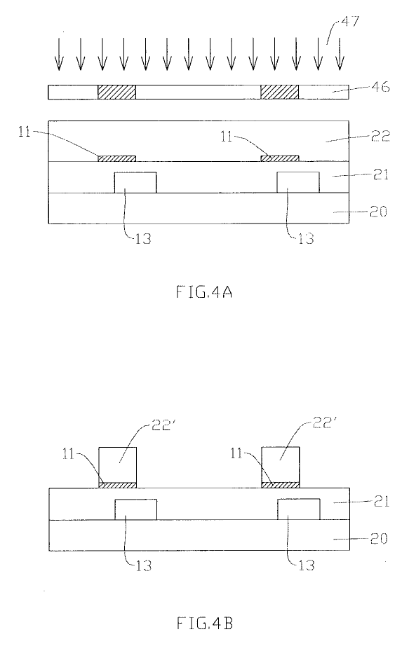

The first embodiment according to this invention is referred to FIG. 1, FIG. 2, FIG. 3A and FIG. 3B. FIG. 1 shows the plan view of color liquid crystal display device. FIG. 2 shows the cross-section view of color liquid crystal display device. FIG. 3A and FIG. 3B are the schematic process figures. First, TFTs (thin film transistors) 13 are formed on the glass substrate 20. TFT 13 can be made by using the ordinary semiconductor process. Then, the glass substrate 20 and TFTs 13 are substantially blanketed with a dielectric layer 21. The scan lines 12 and the data lines 11 crossed vertically the scan lines 12 are formed on the dielectric layer 21 in the matrix pattern, wherein the scan lines 12, the data lines 11 and TFTs 13 are connected electrically. Next, as illustrated in FIG. 3A, a photoresist layer 22 is formed on the dielectric layer 21 and the glass substrate 20 is irradiated with a light rays 23, which is put below the glass substrate 20, by using the scan lines 12 and the data lines 11 as the photomask. The light rays 23 can be G-line, I-line, or deep ultraviolet rays. The photoresist layer 22 that is not covered with the scan lines 12 and the data lines 11 is exposed under the light rays 23, so the photoresist on the above areas will be removed by developer to expose the dielectric layer 21 in later development process. In fact, the areas exposed the dielectric layer 21 are the pixel areas 15. Finally, By using the residual photoresist 22′ on the scan lines 12 and the data lines 11 as the spacers and the ink-jet printing method from an inkjet-printing device, the color materials having RGB colors printed on the pixel areas 15 of glass substrate 20 can be implemented. In this manner, the pixel areas 15 of glass substrate 20 will be colored to fabricate the color filter. The residual photoresist 22′ can be removed or not.

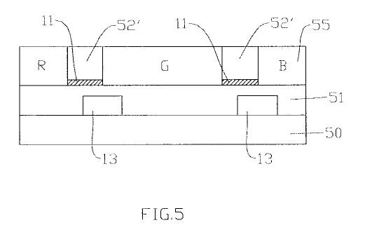

The second embodiment according to this invention is referred to FIG. 1, FIG. 2, FIG. 4A and FIG. 4B. FIG. 1 shows the plan view of color liquid crystal display device. FIG. 2 shows the cross-section view of color liquid crystal display device. FIG. 4A and FIG. 4B are the schematic process figures. First, TFTs (thin film transistors) 13 are formed on the glass substrate 20. TFT 13 can be made by using the ordinary semiconductor process. Then, the glass substrate 20 and TFTs 13 are substantially blanketed with a dielectric layer 21. The scan lines 12 and the data lines 11 crossed vertically the scan lines 12 are formed on the dielectric layer 21 in the matrix pattern, wherein the scan lines 12, the data lines 11 and TFTs 13 are connected electrically. Next, as illustrated in FIG. 4A, a photoresist layer 22 is formed on the dielectric layer 21 and the glass substrate 20 is irradiated with a light rays 47, which is put above the glass substrate 20, after a photomask 46 is inserted above the glass substrate 20. The pattern over the non-pixel area of glass substrate 20 on photomask 46 is opaque, so the photoresist layer 22 which is not covered with the pattern of photomask 46 is selectively exposed under light rays 47, which can be G-line, I-line, or deep ultraviolet rays. So the photoresist on the above areas will be removed by developer to expose the dielectric layer 21 in later development process. In fact, the areas exposed the dielectric layer 21 are the pixel areas 15. Finally, By using the residual photoresist 22′ on dielectric layer 21 as the spacers and the ink-jet printing method from an inkjet-printing device, the color materials having RGB colors printed on the pixel areas 15 of glass substrate 20 can be implemented. In this manner, the pixel areas 15 of glass substrate 20 will be colored to fabricate the color filter. The residual photoresist 22′ can be removed or not.

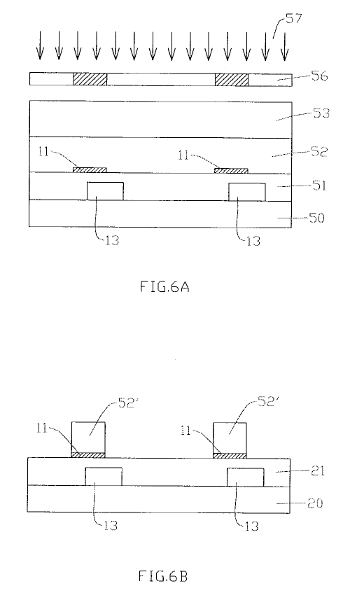

The third embodiment according to this invention is referred to FIG. 1, FIG. 5, FIG. 6A and FIG. 6B. FIG. 1 shows the plan view of color liquid crystal display device. FIG. 5 shows the cross-section view of color liquid crystal display device. FIG. 6A and FIG. 6B are the schematic process figures. First, TFTs (thin film transistors) 13 are formed on the glass substrate 50. TFT 13 can be made by using the ordinary semiconductor process. Then, the glass substrate 50 and TFTs 13 are substantially blanketed with a dielectric layer 51. The scan lines 12 and the data lines 11 crossed vertically the scan lines 12 are formed on the dielectric layer 51 in the matrix pattern, wherein the scan lines 12, the data lines 11 and TFTs 13 are connected electrically. Next, as illustrated in FIG. 6A, another dielectric layer 52, which can be a SiO₂ layer or a SiN layer, is formed on the dielectric layer 51. A photoresist layer 53 is formed on the dielectric layer 52 and the glass substrate 50 is irradiated with a light rays 57, which is put above the glass substrate 50, after a photomask 56 is inserted above the glass substrate 50. The pattern over the non-pixel area of glass substrate 50 on photomask 56 is opaque, so the photoresist layer 53 which is not covered with the pattern of photomask 56 is selectively exposed under light rays 57, which can be G-line, I-line, or deep ultraviolet rays. So the photoresist on the above areas will be removed by developer to expose the dielectric layer 52 in later development process. In fact, the areas exposed the dielectric layer 52 are the pixel areas 15. The following steps are etching dielectric layer 52 by an anisotropic etching method and removing the residual photoresist layer. Finally, By using the residual dielectric layer 52′ on dielectric layer 51 as the spacers and the inkjet printing method from an inkjet-printing device, the color materials having RGB colors printed on the pixel areas 15 of glass substrate 50 can be implemented. In this manner, the pixel areas 15 of glass substrate 50 will be colored to fabricate the color filter.

Although the specific embodiment has been illustrated and described, it will be obvious to those skilled in the art that various modifications may be made without departing from what is intended to be limited solely by the appended claims.

What is claimed is:

1. A method for fabricating color filter, comprising:
forming a dielectric layer on a first surface of a substrate;
forming a plurality of scan lines and a plurality of data lines on said first surface of said substrate to define a plurality of pixel areas and a non-pixel area;
forming a photo-sensitive material layer on said dielectric layer;
irradiating said substrate with a light rays from a second surface of said substrate located below said first surface of said substrate;
developing said photo-sensitive material layer; and
printing a color material on said plurality of pixel areas by inkjet printing method.

2. The method for fabricating color filter according to claim 1, wherein said scan lines and said data lines cross vertically.

3. The method for fabricating color filter according to claim 1 further comprising a plurality of thin film transistors (TFTs) formed on said substrate.

4. The method for fabricating color filter according to claim 3, wherein said scan lines, said data lines and said TFTs are connected electrically.

5. The method for fabricating color filter according to claim 1, wherein said light rays is selected from the group consisting of G-line, I-line and deep ultraviolet rays.

6. The method for fabricating color filter according to claim 1, wherein said photo-sensitive material layer is a photoresist layer.

7. The method for fabricating color filter according to claim 1, wherein the step of printing a color material on said plurality of pixel areas by inkjet printing method further comprises removing said developed photo-sensitive material layer.

8. A method for fabricating color filter, comprising:
forming a dielectric layer on a substrate;
forming a plurality of scan lines and a plurality of data lines on said substrate to define a plurality of pixel areas and a non-pixel area;
forming a photo-sensitive material layer on said dielectric layer;
inserting a photomask above said substrate;
irradiating said substrate with a light rays through said photomask;
developing said photo-sensitive material layer; and
printing a color material on said plurality of pixel areas by inkjet printing method.

9. The method for fabricating color filter according to claim 8, wherein said scan lines and said data lines cross vertically.

10. The method for fabricating color filter according to claim 8 further comprising a plurality of thin film transistors (TFTs) formed on said substrate.

11. The method for fabricating color filter according to claim 10, wherein said scan lines, said data lines and said TFTs are connected electrically.

12. The method for fabricating color filter according to claim 8, wherein the pattern of said photomask over said non-pixel area is opaque.

13. The method for fabricating color filter according to claim 8, wherein said light rays is selected from the group consisting of G-line, I-line and deep ultraviolet rays.

14. The method for fabricating color filter according to claim 8, wherein said photo-sensitive material layer is a photoresist layer.

15. The method for fabricating color filter according to claim 8, wherein the step of printing a color material on said plurality of pixel areas by inkjet printing method further comprises removing said developed photo-sensitive material layer.

16. A method for fabricating color filter, comprising:
forming a first dielectric layer on a substrate;
forming a plurality of scan lines and a plurality of data lines on said substrate to define a plurality of pixel areas and a non-pixel area;
forming a second dielectric layer on said first dielectric layer;
forming a photoresist layer on said second dielectric layer;
inserting a photomask above said substrate;
irradiating said substrate with a light rays through said photomask;
developing said photoresist layer;
etching said second dielectric layer; and
printing a color material on said plurality of pixel areas by inkjet printing method.

17. The method for fabricating color filter according to claim 16, wherein said scan lines and said data lines cross vertically.

18. The method for fabricating color filter according to claim 16 further comprising a plurality of thin film transistors (TFTs) formed on said substrate.

19. The method for fabricating color filter according to claim 18, wherein said scan lines, said data lines and said TFTs are connected electrically.

20. The method for fabricating color filter according to claim 16, wherein the pattern of said photomask over said non-pixel area is opaque.

21. The method for fabricating color filter according to claim 16, wherein said light rays is selected from the group consisting of G-line, I-line and deep ultraviolet rays.

22. The method for fabricating color filter according to claim 16, wherein said dielectric layer is etched by an anisotropic etching method.

23. The method for fabricating color filter according to claim 16, wherein the step of etching said second dielectric layer further comprises removing said developed photoresist layer.
